(19) United States
(12) Patent Application Publication
(10) Pub. No.: US 2013/0031485 A1
(43) Pub. Date: Jan. 31, 2013

(54) MOBILE BUSINESS INTELLIGENCE DYNAMIC ADAPTOR

(71) Applicants: PIN ZHOU CHEN, Diamond Bar, CA (US); James M. Barnett, Rancho Santa Margarita, CA (US)

(72) Inventors: PIN ZHOU CHEN, Diamond Bar, CA (US); James M. Barnett, Rancho Santa Margarita, CA (US)

(21) Appl. No.: 13/194,888

(22) Filed: Jul. 29, 2011

(51) Int. Cl. G06F 3/048

(52) U.S. Cl. 715/748

(57) ABSTRACT

A system and method for delivering business intelligence content to one or more mobile devices from multiple source reporting systems comprise a dynamic adaptor utilizing a networking protocol. The dynamic adaptor comprises at least one source specific adaptor that abstracts interaction with the at least one source reporting system and generates the result in a common format as metadata. A metadata manager is employed for storing, processing, and retrieving an information describing the at least one metadata from the at least one source specific adaptor. A presentation engine combines the metadata with the information from the at least one source specific adaptor that corresponds to an object selected by a user. The common report metadata is utilized to retrieve the at least one information from the metadata manager and to selectively combine with the metadata when the user requests for the previously retrieved information.

### BACKGROUND OF THE INVENTION

This application claims the benefit of U.S. Provisional Application No. 61/368,643 filed on Jul. 28, 2010.

### TECHNICAL FIELD OF THE INVENTION

The present invention relates in general to system and method for accessing business intelligence content utilizing a wide variety of mobile devices. More specifically, the embodiment relates to a method and system for retrieving business intelligence content and reports from a diverse number of reporting systems utilizing a wide variety of mobile devices.

### DESCRIPTION OF THE RELATED ART

Mobile devices play a significant role in today's industries with the advent of new features and applications. Mobile devices offer a wide variety of applications that allow the users to perform online transactions, shopping, online auctions and the like. One of such features is the ability to easily access business intelligence content on mobile devices.

Mobile business intelligence refers to the distribution of business data to mobile devices. Mobile business intelligence responds to immense market pressures such as the demand for highly effective business processes, the improvement of employee productivity, better and quicker decision making, improved customer service etc. The conventional method for accessing business intelligence information is by installing proprietary software.

Currently available methods and systems for displaying business intelligence content on a mobile phone require the installation of client-specific applications on each mobile device. Also organizations that utilize solutions from multiple vendors are required to run multiple services, one for each vendor solution and require end users to connect separately to each service. For example, Oracle Corporation's currently available system and method for displaying business intelligence on a mobile device supports only Apple's iPhone and iPad. This system is not able to address the requirements of customers who rely on Blackberry or similar devices.

Hence, it can be seen that, there is a need for a system and method which would deliver business intelligence content on a wide variety of mobile devices without the installation of a client-specific application on the phone. Such a needed system and method would allow the user to access business intelligence content from one or more reporting systems and to deliver the required content for mobile devices without reprogramming or making changes to the source reporting software. This system would not require the installation of software on a mobile device other than a standard internet web browser which is already installed on the mobile device. Further, the system would have the capability of allowing both simple and advanced browsers to consume the same content. Finally, system and method would allow the user to intuitively access, navigate and analyze business reports to enable rapid business decision-making.

### SUMMARY OF THE INVENTION

To minimize the limitations found in the prior art, and to minimize other limitations that will be apparent upon the reading of the specifications, the present invention is a system and method for delivering at least one business intelligence content to at least one mobile device from at least one source reporting system. A dynamic adaptor is configured to deliver the at least one business intelligence content to the at least one mobile device utilizing a networking protocol such as a Hyper Text Transfer Protocol (HTTP) and/or a Hyper Text Transfer Protocol Secure (HTTPS). The dynamic adaptor comprises at least one source specific adaptor that abstracts interaction with the at least one source reporting system and generates the result in a common format as at least one metadata. The interaction may include compilation of the metadata, processing of data retrieval request, conversion of data to a common format, and retrieval of user and security information. A metadata manager is employed for storing, processing, and retrieving at least one information describing the at least one metadata from the at least one source specific adaptor. A presentation engine combines the metadata with the at least one information from the at least one source specific adaptor that corresponds to at least one object selected by a user. The common report metadata associated to the dynamic adaptor retrieves the information from the metadata manager and selectively combines with the metadata when the user requests for at least one previously retrieved information.

The user employs the at least one mobile device having a minimum web browsing capability to communicate to a web server through the networking protocol. The at least one mobile device does not require an installation of any client specific application for accessing the at least one business intelligence content. The web server communicates with the dynamic adaptor which in turn communicates with the at least one source reporting system to determine the at least one object available to the user and sends a list of the at least one available object to the user. The at least one object available to the user may include reports, graphs, queries, dashboards and other data visualization methods. When the at least one object is selected for display, the request is transferred to the web server. Then the web server utilizes the dynamic adaptor to convert the at least one object into a common format metadata and send to the at least one source reporting system for execution. The dynamic adaptor then combines the information from the common report metadata with the data retrieved from the execution of the at least one object on the at least one source reporting system to generate the at least one business intelligence content. The dynamic adaptor determines the level of web browsing capability of the at least one mobile device and formats the content for display on the at least one mobile device based on the level of web browsing capability and transfers the at least one business intelligence content to the at least one mobile device through the HTTP and/or the HTTPS. The dynamic adaptor uses various methods to communicate with the at least one source reporting system. The various methods may include web services, Application Programming Interface (API) calls, Software Development Kit (SDK), Open Database Connectivity (ODBC) and the like.

One objective of the present invention is to provide a system and method for delivering at least one business intelligence content from at least one source reporting system to at least one mobile device.

Another objective of the present invention is to provide a dynamic adaptor capable to consolidate the business intelligence content from multiple source reporting systems and to deliver the business intelligence content to the mobile device.

A third objective of the invention is to provide a system that does not require the installation of any client specific application on a mobile device other than a standard internet web browser.

Yet another objective of the invention is to provide a system which helps to deliver the required content to the multiple mobile devices without reprogramming or making changes to the source reporting system.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a schematic representation of the present invention, illustrating a high level architecture of the invention;

FIG. 2 is a schematic representation of the present invention, illustrating a high level process flow of the invention; and

FIG. 3 is a flow chart, illustrating a method for allowing a system to deliver at least one business intelligence content to the at least one mobile device from at least one source reporting system.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

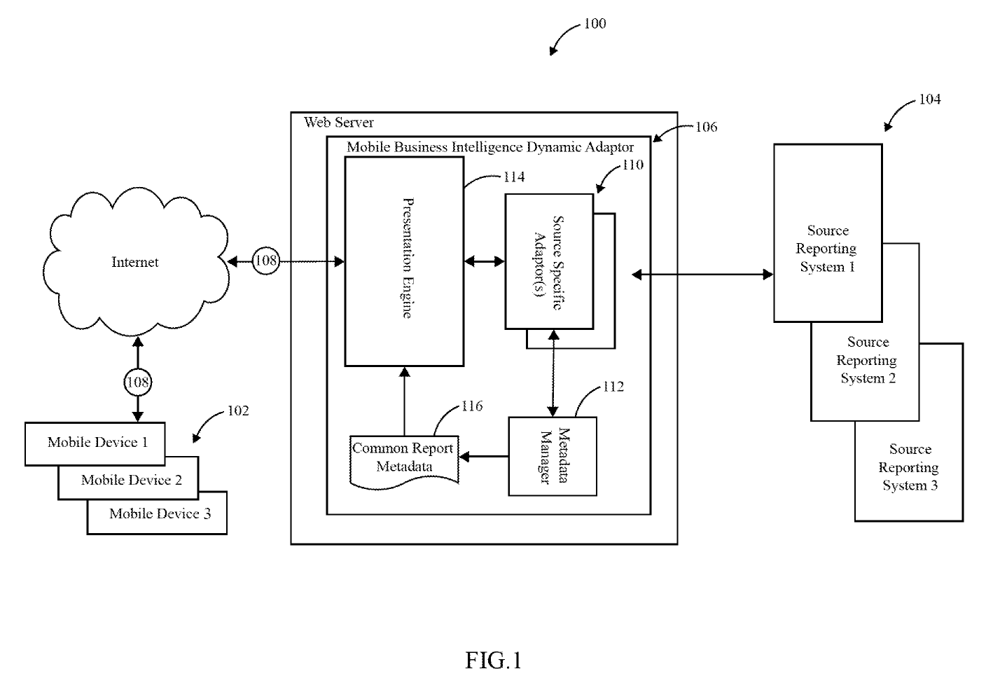

FIG. 1 shows a high level architecture of a system for delivering at least one business intelligence content 100 to at least one mobile device 102 from at least one source reporting system 104. A dynamic adaptor 106 configured to deliver the at least one business intelligence content to the at least one mobile device 102 utilizing a networking protocol 108. The networking protocol 108 may be a Hyper Text Transfer Protocol (HTTP) or a Hyper Text Transfer Protocol Secure (HTTPS). The dynamic adaptor 106 comprises at least one source specific adaptor 110 that abstracts interaction with the at least one source reporting system 104 and generates the result in a common format as at least one metadata. The interaction may include compilation of the at least one metadata, processing of data retrieval request, conversion of data to a common format, and retrieval of user and security information. A metadata manager 112 is employed for storing, processing, and retrieving at least one information describing the at least one metadata from the at least one source specific adaptor 110. The web server utilizes the dynamic adaptor to execute the request and access the at least one object selected by the user utilizing the at least one source specific adaptor 110, retrieve the at least one metadata combined with information, and send the at least one object to the at least one source reporting system for execution and information retrieval. A presentation engine 114 generates a result by combining the at least one metadata with the at least one information from the at least one source specific adaptor 110 that corresponds to at least one object selected by a user. The common report metadata 116 is employed to retrieve the at least one information from the metadata manager 112 and to selectively combine with the at least one metadata when the user requests for at least one previously retrieved information.

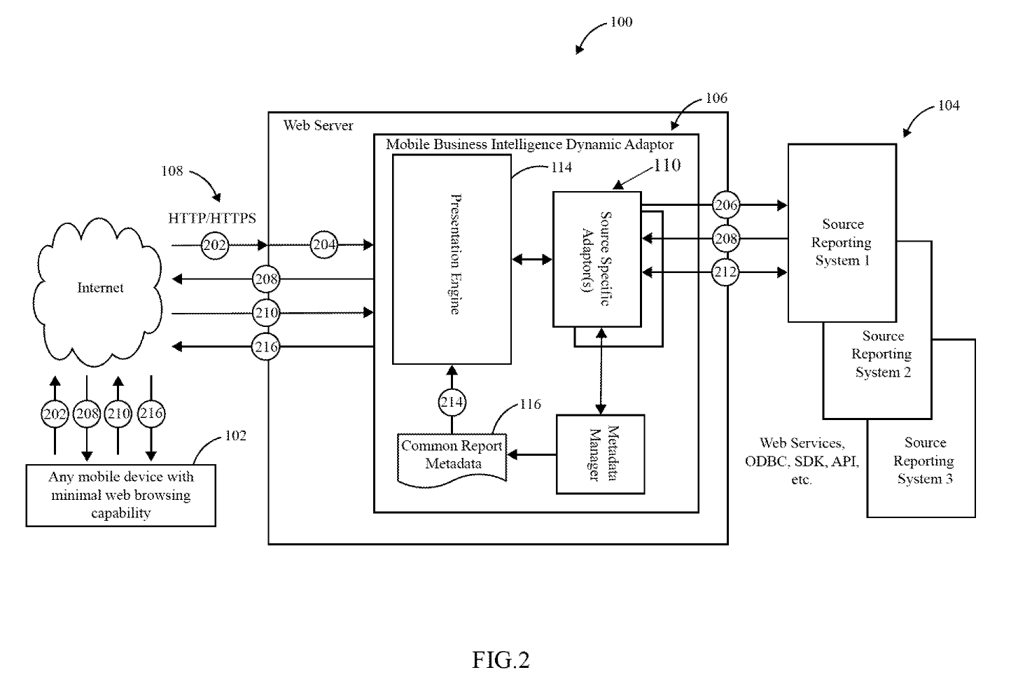

FIG. 2 shows a high level process flow of the system 100. The process is initiated with activity 202 when the user employs the at least one mobile device 102 with a minimum web browsing capability to communicate to a web server through the networking protocol 108. The at least one mobile device 102 does not require an installation of any client specific application for accessing the at least one business intelligence content. As shown in activity 204 the web server communicates with the dynamic adaptor 106 which in turn communicates with the at least one source reporting system 104 to determine the at least one object available to the user as indicated in activity 206 and sends the list of the at least one available object to the user as indicated in activity 208. The at least one object available to the user may include reports, graphs, queries, dashboards and other data visualization methods. When the at least one object is selected for display, the request is transferred to the web server as shown in activity 210. Then the web server utilizes the dynamic adaptor 106 to execute the request and as indicated in activity 212 convert the at least one object into a common format metadata and send to the at least one source reporting system 104 for execution and information retrieval. As shown in activity 212 the at least one metadata and the information results can be retrieved from the at least one source reporting system 104 through the dynamic adaptor 106 and converted into a common format. As shown in activity 214 a presentation engine 114 generates the result by combining metadata with the information from the at least one source reporting system 104. The dynamic adaptor 106 determines the level of web browsing capability of the at least one mobile device 102 and display the result on the at least one mobile device 102 based on the level of web browsing capability and transfer the at least one business intelligence content to the at least one mobile device 102 through the HTTP and/or the HTTPS as shown in activity 216. The dynamic adaptor 106 uses various methods to communicate with the at least one source reporting system 104. The various methods may include web services, application programming interface (API) calls, Software Development Kit (SDK), Open Database Connectivity (ODBC) and the like.

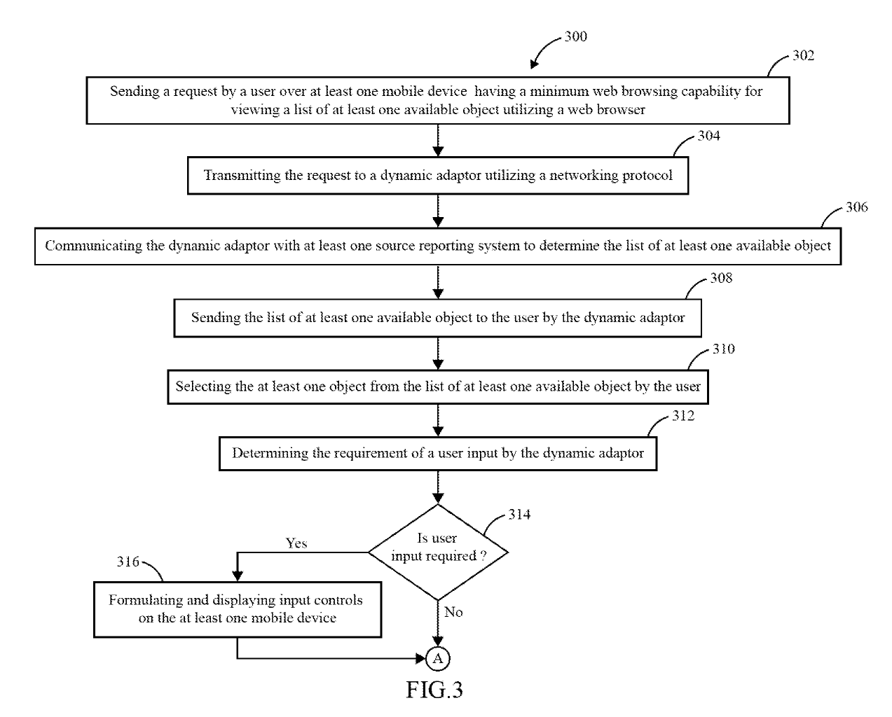

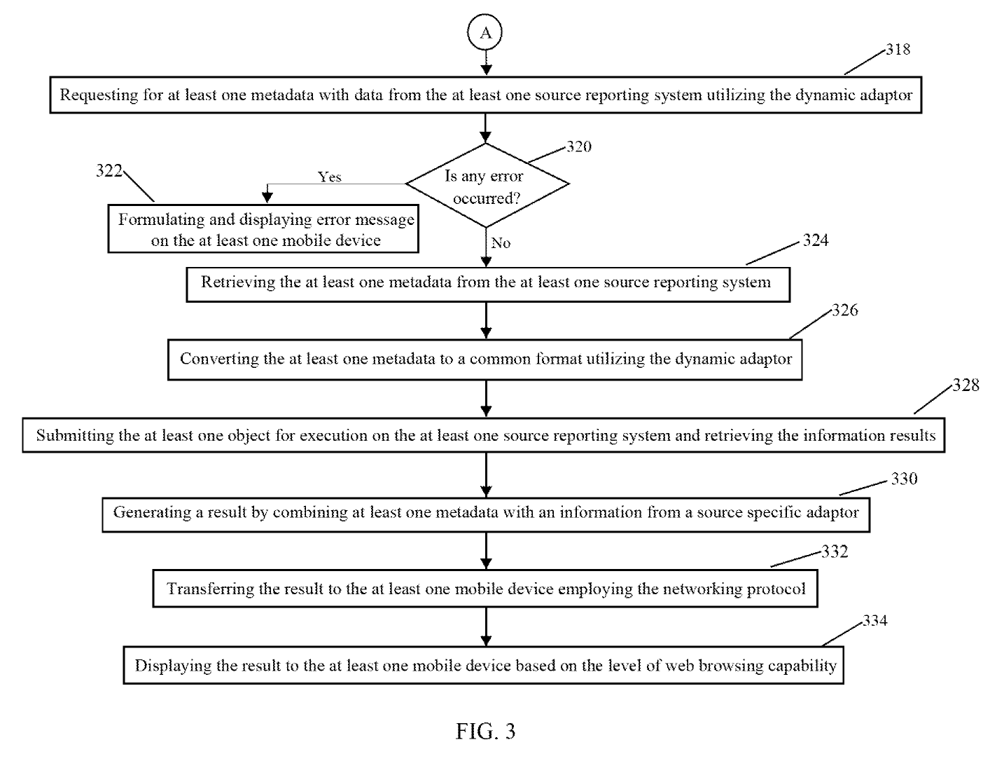

FIG. 3 shows a flowchart 300 illustrating a method for allowing a system to deliver at least one business intelligence content to the at least one mobile device from at least one source reporting system. As indicated at block 302, the process is initiated by sending a request over at least one mobile device by a user to view a list of available objects utilizing a web browser. Then the request is transferred to a dynamic adapter utilizing a networking protocol as indicated at block 304. The dynamic adaptor communicates with the at least one source reporting system to determine the list of at least one available object as shown in the block 306. Thereafter as indicated at block 308 the list of at least one available object is sent to the dynamic adaptor. The user selects the at least one object from the list of at least one available object as indicated at block 310 and determines the requirement of the user input by reading a common report metadata employing the dynamic adaptor as indicated at block 312. If the user input is required as shown in block 314 then relevant input controls are formulated and displayed for user input on the at least one mobile device as at block 316. If the user input is not required then the dynamic adaptor reads the common report metadata and sends the request to the at least one source reporting system for retrieving the at least one metadata as shown in block 318. If an error is occurred as indicated at block 320 then the system formulates and displays an error message as the dynamic adaptor is not capable to retrieve the at least one metadata from the at least one source reporting system as shown in block 322, and as a result the process gets terminated, else the at least one metadata is retrieved from the at least one source reporting system as indicated at block 324. The dynamic adaptor converts the at least one metadata to a common format as indicated at block 326, and executes the at least one object on the at least one source reporting system and retrieves the information results as indicated in block 328. Then the dynamic adaptor generates the result by combining metadata with the information from the at least one source specific adaptor as indicated in block 330. The result is transferred to the at least one mobile device employing the networking protocol as shown in block 332 and finally displaying the result to the at least one mobile device based on the level of web browsing capability as indicated at block 334.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A system for delivering at least one business intelligence content to at least one mobile device from at least one source reporting system comprising:
a dynamic adaptor configured to deliver the at least one business intelligence content to the at least mobile device utilizing a networking protocol, the dynamic adaptor comprising:
at least one source specific adaptor that abstracts interaction with the at least one source reporting system and generates results in a common format as at least one metadata, and is able to use that metadata to execute requests on the at least one source system to retrieve information results;
a metadata manager employed for storing, processing, and retrieving at least one information describing the at least one metadata from the at least one source specific adaptor;
a presentation engine employed to combine the at least one metadata with the at least one information from the at least one source specific adaptor that corresponds to an object selected by a user; and
a common report metadata employed to retrieve the at least one information from the metadata manager and to selectively combine with the at least one metadata when the user requests for at least one previously retrieved information;
whereby the dynamic adaptor is capable to consolidate the at least one business intelligence content from the at least one source reporting system and delivering the at least one business intelligence content to the at least one mobile device having a minimum web browsing capability.

2. The system of claim 1 wherein the at least one source specific adaptor is configured to interact with the at least one source reporting system to access a metadata.

3. The system of claim 1 wherein the interaction may include compilation of metadata, processing of data retrieval request, conversion of data to a common format, and retrieval of user and security information.

4. The system of claim 1 wherein the dynamic adaptor may include the at least one source specific adaptor, presentation engine, metadata manager and common report metadata.

5. The system of claim 1 wherein the networking protocol may be a Hyper Text Transfer Protocol (HTTP).

6. The system of claim 1 wherein the networking protocol may be a Hyper Text Transfer Protocol Secure (HTTPS).

7. The system of claim 1 wherein the dynamic adaptor utilizes methods such as web services, Application Programming Interface (API) calls, Software Development Kit (SDK), and Open Database Connectivity (ODBC) to communicate with the at least one source reporting system.

8. The system of claim 1 wherein the at least one source specific adaptor is configured to interact with the at least one source reporting system to access a metadata, execute requests, and retrieve information results.

9. The system of claim 1 wherein the presentation engine combines the metadata and the common report metadata retrieved from the at least one source reporting system.

10. The system of claim 1 wherein the at least one mobile device does not require the installation of any client specific application for accessing the metadata.

11. A method for allowing a system to deliver at least one business intelligence content to at least one mobile device from at least one source reporting system, the method comprising the steps of:
a) sending a request by a user over at least one mobile device having a minimum web browsing capability for viewing a list of at least one available object utilizing a web browser;
b) transmitting the request to a dynamic adapter utilizing a networking protocol;
c) communicating the dynamic adaptor with at least one source reporting system to determine the list of the at least one available object;
d) sending the list of the at least one available object to the user by the dynamic adaptor;
e) selecting the at least one object from the list of the at least one available object by the user;
f) determining the requirement of the user input by the dynamic adaptor;
g) sending the at least one selected object to the at least one source reporting system utilizing the dynamic adaptor;
h) retrieving at least one metadata from the at least one source reporting system utilizing the dynamic adaptor;
i) converting the at least one metadata to a common format utilizing the dynamic adaptor;
j) submitting the at least one object for execution on the at least one source reporting system and retrieving the information results;
k) generating a result by combining the at least one metadata with an information from at least one source specific adaptor;
l) transferring the result to the at least one mobile device employing the networking protocol; and
m) displaying the result to the at least one mobile device based on the level of web browsing capability.

12. The method of claim 11 wherein the step f) further comprises:
f1) requiring a user input for processing the request.

13. The method of claim 12 wherein the step fl) further comprises:
f2) formulating and displaying input controls on the at least one mobile device for entering the user input.

14. The method of claim 12 wherein the step f1 is optional.

15. The method of claim 11 wherein the networking protocol may be a Hyper Text Transfer Protocol (HTTP).

16. The method of claim 11 wherein the networking protocol may be a Hyper Text Transfer Protocol Secure (HTTPS).

17. The method of claim 11 wherein the objects may include reports, graphs, queries, dashboards and other data visualization methods.

18. The method of claim 17 wherein the objects may be previously imported into the system from the at least one source reporting system to allow the mobile enablement.

19. The method of claim 11 wherein the system formulates and display an error message when the dynamic adaptor is not capable to retrieve the metadata from the source reporting system, or execute information requests on the source reporting system.

20. The method of claim 11 wherein the at least one source reporting system may represent an external system for providing visualization, online analytical processing, reporting, dash boarding, data presentation and data visualization services.
